(19) United States
(12) Patent Application Publication
(10) Pub. No.: US 2024/0073719 A1
(43) Pub. Date: Feb. 29, 2024

(54) NETWORK NODE AND METHOD IN A WIRELESS COMMUNICATIONS NETWORK

(71) Applicant: Telefonaktiebolaget LM Ericsson (publ), Stockholm (SE)

(72) Inventors: Indranil GHOSH, Kolkata (IN); Faiz Ahmad KHAN, Järfälla (SE)

(73) Assignee: Telefonaktiebolaget LM Ericsson (publ), Stockholm (SE)

(21) Appl. No.: 18/260,237

(22) PCT Filed: Jan. 26, 2021
(86) PCT No.: PCT/SE2021/050046

§ 371 Date: Jun. 30, 2023

(51) Int. Cl. H04W 24/08; H04W 76/15

(52) U.S. Cl. CPC H04W 24/08; H04W 76/15

(57) ABSTRACT

A method performed by a first network node for selecting a secondary cell for a first wireless device is provided. The first network node configures the first wireless device with a first threshold value relating to a signal quality for determining whether any secondary cell candidate(s) shall be reported to the first network node. The first network node receives a first report comprising a signal quality for secondary cell candidate whose measured signal quality meets the first threshold value. The first network node selects a first secondary cell candidate. The first network node instructs the first wireless device to attach to the first secondary cell candidate. The first network node detects that the first wireless device has failed a first series of random access attempts to the first secondary cell candidate. The first network node configures the first wireless device with a better second threshold value.

### TECHNICAL FIELD

Embodiments herein relate to a network node and a method therein. In some aspects they relate to selecting a first secondary cell for supporting split bearer mode with a first wireless device in a wireless communications network.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

Non-Standalone

5G NR provides a Non-Standalone (NSA) mode which refers to an option of 5G NR deployment that depends on the control plane of an existing 4G LTE network for control functions. NR NSA mode may also be referred to as E-UTRAN NR— Dual Connectivity (EN-DC). In NR, NSA deployment utilization of an LTE network is mandatory through which basic wireless devices, e.g. UEs, access, mobility and important control signalling is handled. There are two options to set up an NSA mode. One is a configuration-based B1 where NSA is set up with fixed target NR cell relations and another is a measurement based B1 where NSA is set up by measuring NR coverage and detecting target NR cells. B1 when used herein means that the evaluation of a cell is based on radio frequency coverage or quality.

B1 Measurements

When an EN-DC capable wireless device intends to access an NR part of the NSA network, the wireless device will be instructed by a connected eNB to perform B1 measurements, and for the measurements which fulfils a B1 threshold, send a B1 event reporting the B1 measurement. A B1 event when used herein means that a neighbour cell, e.g. an NR cell, is evaluated to be better than a specified B1 threshold during a specified evaluation period also referred to as a B1 time to trigger. The B1 measurements are e.g. to determine if an NR cell has a sufficiently high quality signal to serve a wireless device. B1 measurements are performed towards neighbouring cells provided by network nodes such as a gNBs and may relate to measuring a signal quality from a Synchronization Signal Block (SSB), e.g. Synchronization Signal Reference Signal Received Power (SS-RSRP, RSRP), or Synchronization Signal Reference Signal Received Quality (SS-RSRQ, RSRQ). This may be a yardstick to measure an NR band of a neighbouring network node such as a gNB. The receipt of a B1 event triggers the network to initiate an EN-DC connection with the wireless device. The EN-DC capable wireless device will be reconfigured to EN-DC mode so that it can simultaneously be connected to both an eNB and a gNB in split-bearer mode.

EN-DC Setup

In scenarios where Downlink (DL) coverage for an NR cell is susceptible but provides poor Uplink (UL), continuous B1 measurement reporting and configuration happens until a UE successfully attaches to NR by a Random Access procedure (RA, RACH). Random access procedure to an NR cell can be performed in two ways, by using a contention based random access procedure, or by using a contention free random access procedure illustrated in FIGS. 1a and 1b respectively. Both FIGS. 1a and 1b illustrates the alternatives for random access procedure in EN-DC between a wireless device 1 and a gNB 2.

Contention Based Random Access

Contention based random access is illustrated in FIG. 1a, e.g. which is always used in scenarios when the wireless device 1 is in idle mode but may also be used in other situations. The contention based random access procedure comprises sending four messages in UL and DL.

The wireless device 1 transmits a random access request message, Message 1, to the gNB 2. The random access requests comprises a preamble. The preamble is selected randomly by the wireless device 1 from a pool of preambles shared with other wireless devices in the cell.

The gNB 2 receives the randomly selected preamble and responds to the wireless device 1 with a random access response message, Message 2, comprising information of the detected preamble and a UL grant for the resource to be used by the wireless device 1 for an L2 or L3 message to be communicated.

The wireless device 1 transmits a scheduled message, Message 3, on UL Shared Channel (UL-SCH). The message comprising a contention resolution identity for the wireless device 1.

The gNB 2 sends a contention resolution message, Message 4, to the one or more wireless devices that are admitted access to the cell. This is based on the identity of the one or more wireless devices as received from the wireless devices in Message 3. Wireless devices whose identity is not included in a contention resolution message within a specific time period determines that the access attempt has failed. They may then make a new attempt by again randomly selecting a preamble and transmit it.

Contention Free Random Access

In the contention free random access procedure the gNB 2 assigns 7 a preamble to the wireless device 1 for accessing a specific cell during a specific time period. It can therefore be used only by wireless devices that are connected to the network and typically in situations such as handover. When accessing a target cell by transmitting the dedicated preamble, the target cell can identify the wireless device 1 by the preamble. This is why the identity and contention resolution messages are skipped in the contention free random access process.

The wireless device 1 sends 8 a message comprising the assigned random access preamble to the gNB 2. Since the preamble is assigned in advance to the wireless device 1, there is no risk of contention.

The wireless device 1 receives 9 from the gNB 2 a random access response comprising a UL grant for an L2 or L3 message to be communicated to the gNB2, which confirms safe receipt of the random access response. Upon receipt of the random access response within a predefined period of time, the wireless device 1 determines that the access attempt is successful. The wireless device 1 then monitors the Physical Downlink Control Channel (PDCCH) for any further scheduled transmissions that continues the communication in the target cell.

Random Access Failure

If any of the messages in the random access procedures fails to be received by the wireless device 1, or the gNB 2, within a predefined period the random access attempt fails. As in both procedures, if any of the messages are not received by the corresponding party, the random access procedure will not succeed. As messages are need be received in both UL and DL, access failure may be due to poor signal quality in either communication direction between the wireless device 1 and the gNB 2.

When facing temporary network disturbances, random access may thus fail even though the radio conditions are generally good. Hence, to mitigate occasional random access failures in these scenarios, multiple random access attempts thus repeated until succeeding, or until a timer expires, e.g. by means of using a T304 timer as specified in 3GPP TS 38.331, or until a maximum number of random access attempts is reached, e.g. as specified according to a predefined system configuration.

EN-DC Setup Scenario

In NR-NSA mode, the EN-DC setup procedure is illustrated in FIG. 2 and explained below as per standard setup of a secondary gNB node, also referred to as an NR leg setup procedure, in RRC Connected mode. The procedure in FIG. 2 involves an EN-DC capable wireless device 10, a Master eNB (MeNB) 11, a gNB 12, and a Mobility Management Entity (MME) 13.-In the example scenario of FIG. 2, the wireless device 10 is connected to the MeNB 11 in an RRC Connected state.

The MME 13 sends 14 to the MeNB 11 an Initial context setup request for setting up a UE context for the wireless device 10. The UE context for the wireless device 10 is a container with information of capabilities of the wireless device 10 that is kept by the MeNB 11. The MeNB 11 may then, based on the UE context, determine if the wireless device 10 is EN-DC capable, how to configure the wireless device 10, e.g. what types of frequencies the wireless device 10 shall measure, what types of frequency carriers the wireless device 10 may operate on, and what type of carrier combinations and RATs are enabled when connected to more than one cell e.g. Multi Radio Access Technology Dual Connectivity (MR-DC), supported LTE anchor band combinations, or supported NR frequencies

The MeNB 11 then receives 15, from the wireless device 10 information about the wireless device 10 capabilities to be comprised in the UE context. The MeNB 11 decides 16 on NR measurement objects based on the UE context of the wireless device 10. A measurement object herein indicates the frequency/time location and subcarrier spacing of reference signals to be measured by a wireless device. The MeNB 11 then sends 17 an RRC Connection Reconfiguration message to wireless device 10 to instruct the wireless device 10 to activate a default radio bearer with the NR measurement objects. The RRC Connection reconfiguration message comprising the NR measurement objects and configured NR B1 event threshold. The wireless device 10 may then respond with an RRC reconfigure complete message indicating completion of the RRC connection reconfiguration. The wireless device 10 is now configured to perform B1 measurements on the NR measurement objects.

The MeNB 11 now responds 18 to the MME 13 with an initial context setup response informing the MME 13 of the wireless device 10 capabilities and the associated UE context.

The wireless device 10 performs B1 measurements, and for the B1 measurements which fulfils a B1 threshold, sends a B1 event to the MeNB 11 reporting the B1 measurements. The MeNB 11 then receives 19, a B1 event from the wireless device 10 reporting one or more NR cells measured, e.g. an NR cell provided by the gNB 12. The MeNB 11 then determines that the wireless device 10 has entered into NR coverage. The MeNB 11 may then select 20 the gNB 12 reported by the B1 event as a target secondary node based on the reported radio quality of its provided NR cell, e.g. from a plurality of gNBs.

A procedure to setup a gNB as a secondary node, also referred to as a Secondary gNB (SgNB) is then initiated by the MeNB 11. The MeNB 11 sends 21 a request to the gNB 12, by sending a SgNB addition request message to the gNB 12. If the gNB 12 admits the resource request, it allocates 22 radio resources and sends 23 to the MeNB 11, an SgNB addition request acknowledge message comprising a Secondary Cell Group (SCG) configuration comprising information of how the gNB 12 is configured and how to connect to the gNB 12.

The MeNB 11 now have enough configuration information to instruct the wireless device 10 to setup an NR connection to the gNB 12. The MeNB 11 then sends 24 to the wireless device 10, an RRC connection reconfiguration comprising configuration information of the gNB 12.

The wireless device 10 applies a new RRC reconfiguration based on the RRC connection reconfiguration message and replies 25 to the MeNB 11 with an RRC reconfiguration complete message. The MeNB 11 informs 26 the selected gNB 12 that the wireless device 10 has completed the reconfiguration procedure successfully by conveying an RRC reconfiguration complete message.

At this point, the RAN state may be declared as being NR EN-DC configured and the wireless device 10 may now attempt to attach to the NR cell of the gNB 12.

The wireless device 10 then proceeds with performing 27 random access to the gNB 12. This may be performed using either contention based or contention free random access.

The random access procedure will now repeat until success, or repeating random access a maximum number of times and/or a maximum amount of time.

If random access still has not succeeded after the multiple attempts, the connection between the wireless device 10 and the gNB 12 has failed to be setup and the wireless device 10 then reverts back to performing B1 measurements, and may continue to measure for a new B1 event, e.g. as previously configured by the MeNB 11 in step 17 above. In this way, the wireless device 10 may eventually find an NR cell to which it may succeed to connect to.

If the random access procedure at any point succeeds, the connection between the wireless device 10 and the gNB 12 is setup and the wireless device 10 may switch data path to the selected gNB 12.

### SUMMARY

As a part of developing embodiments herein a problem was identified by the inventors and will first be discussed.

NR is operated at one or more frequency bands, some of which being of much higher frequency than those of LTE and having much higher bandwidth and capacity than LTE. It is therefore attractive to push traffic to the NR cells, and in an attempt to do so configure wireless devices with a relatively low B1 threshold, thus triggering more B1 events and thus increasing the attempts to attach wireless devices to NR cells. However, a problem arises in that unless an EN-DC connectivity is successfully established for a B1 event, further attempts to establish EN-DC connectivity consumes significant resources in terms of signalling.

An object of embodiments herein is thus to improve use of resources for signalling while enabling EN-DC connectivity to be established also when the signal strength or signal quality of the NR cell is relatively low.

According to an aspect of embodiments herein, the object is achieved by a method performed by a first network node for selecting a first secondary cell for supporting split bearer mode with a first wireless device in a wireless communications network. The first wireless device is one in a group of wireless devices for which a first cell provided by the first network node acts as a primary cell. The group of wireless devices are configured to measure the signal quality of secondary cell candidates. The first network node configures the group of wireless devices with a first threshold value relating to a measured signal quality for determining whether any secondary cell candidate/s shall be reported to the first network node. The first network node receives from the first wireless device, a first report comprising a measured signal quality for a respective one or more secondary cell candidate whose measured signal quality meets the first threshold. The first network node selects for the first wireless device, among the one or more secondary cell candidates as is/are received in the first report, a first secondary cell candidate, based on the first report. The first network node instructs the first wireless device to attach to the first secondary cell candidate. In response to detecting that the first wireless device has failed a first series of random access attempts to the first secondary cell candidate, the first network node configures the first wireless device with a second threshold value that for a time period shall be used by the wireless device instead of the first threshold value for determining whether any secondary cell candidate/s shall be reported to the first network node. The second threshold value relates to a better signal quality than the first threshold value.

According to another aspect of embodiments herein, the object is achieved by a first network node configured to select a first secondary cell for supporting split bearer mode with a first wireless device in a wireless communications network. The first wireless device is arranged to be one in a group of wireless devices for which a first cell provided by the first network node acts as a primary cell. The group of wireless devices are adapted to be configured to measure the signal quality of secondary cell candidates. The first network node further is configured to:

Configure the group of wireless devices with a first threshold value relating to a measured signal quality for determining whether any secondary cell candidate/s shall be reported to the first network node,
receive from the first wireless device, a first report comprising a measured signal quality for a respective one or more secondary cell candidate whose measured signal quality is arranged to meet the first threshold,
select, for the first wireless device, among the one or more secondary cell candidates as is/are arranged to be received in the first report, a first secondary cell candidate, based on the first report,
instruct the first wireless device to attach to the first secondary cell candidate, and
detect that the first wireless device has failed a first series of random access attempts to the first secondary cell candidate,
configure the first wireless device with a second threshold value that for a time period shall be used by the wireless device instead of the first threshold value for determining whether any secondary cell candidate/s shall be reported to the first network node, wherein the second threshold value is adapted to relate to a better signal quality than the first threshold value,
in response to detecting that the first wireless device has failed the first series of random access attempts to the first secondary cell candidate, the first network node configures the first wireless device with a second threshold value that for a time period shall be used by the wireless device instead of the first threshold value for determining whether any secondary cell candidate/s shall be reported to the first network node. The second threshold value relates to a better signal quality than the first threshold value.

Since the first network node detects that the first wireless device has failed the first series of random access attempts, the first network node configures the first wireless device with the second threshold value, and hence, unnecessary measurements and communications relating to secondary cells with low signal quality is avoided. This is since the second threshold value relates to a better signal quality than the first threshold value and thus, secondary cells with poor signal quality will not be considered for future connection attempts.

### BRIEF DESCRIPTION OF THE DRAWINGS

Examples of embodiments herein are described in more detail with reference to attached drawings in which:

FIGS. 1a-b are sequence diagrams illustrating prior art.

FIG. 2 is a sequence diagram illustrating prior art.

FIG. 3 is a sequence diagram illustrating prior art.

FIG. 4 is a schematic block diagram illustrating embodiments of a wireless communications network.

FIG. 5 is a flowchart illustrating an embodiment of a method in a network node.

FIG. 6 is a sequence diagram illustrating embodiments herein.

FIG. 7 is a diagram illustrating embodiments herein.

FIGS. 8a-b are schematic block diagrams illustrating embodiments of a network node.

FIG. 9 schematically illustrates a telecommunication network connected via an intermediate network to a host computer.

FIG. 10 is a generalized block diagram of a host computer communicating via a base station with a user equipment over a partially wireless connection.

FIGS. 11-14 are flowcharts illustrating methods implemented in a communication system including a host computer, a base station and a user equipment.

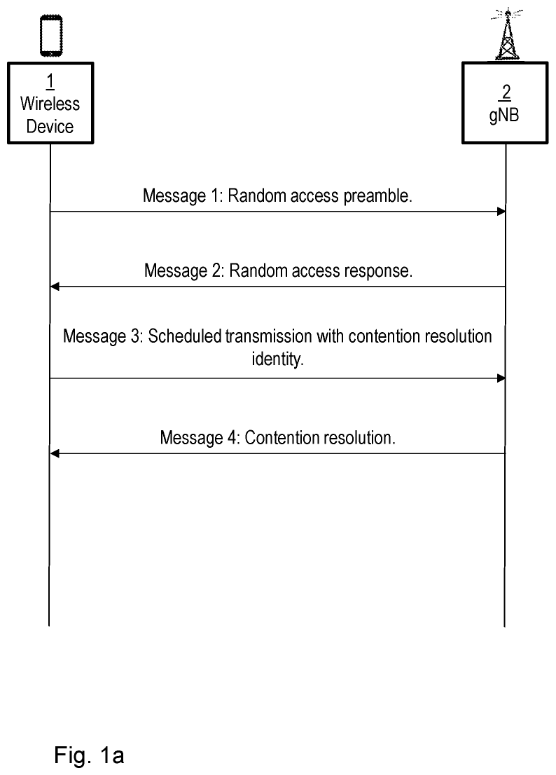

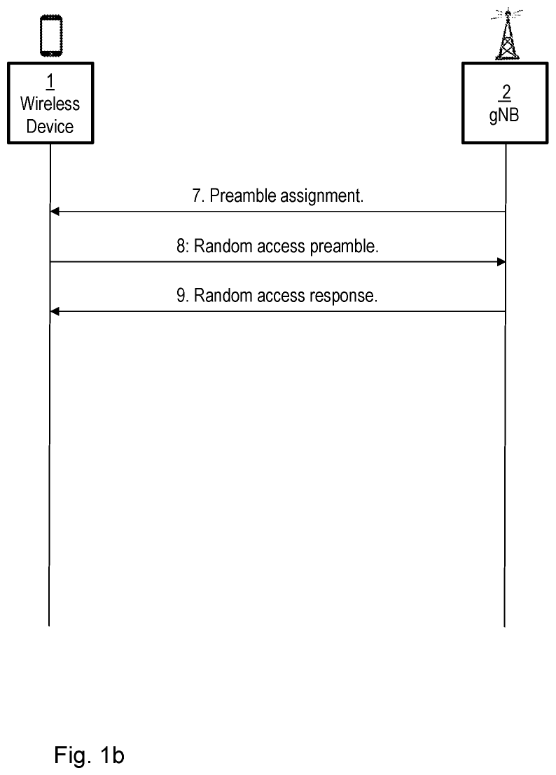

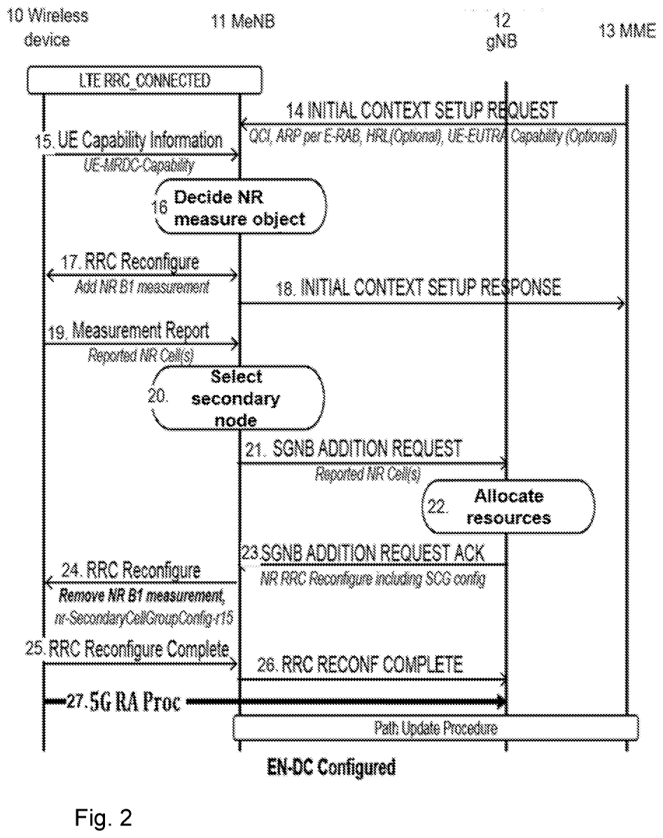

### DETAILED DESCRIPTION

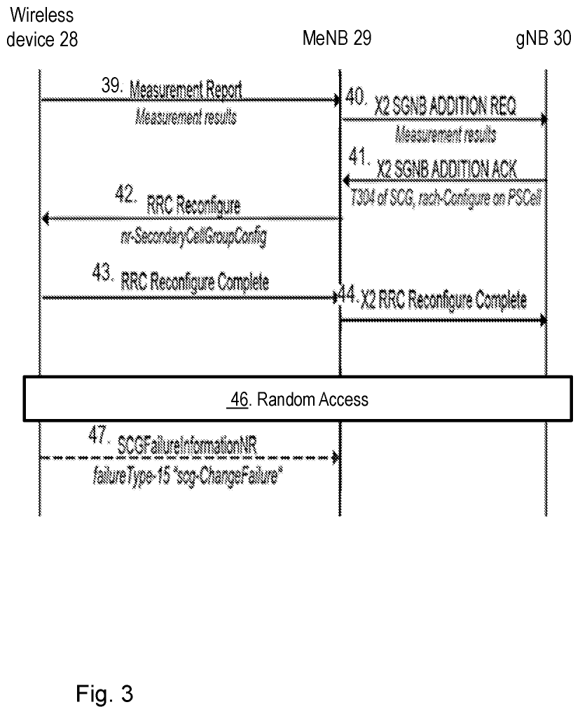

FIG. 3 illustrates a problem scenario identified by the inventors as part of developing embodiments herein and will be explained in more detail. In the example scenario of FIG. 3, an EN-DC capable wireless device 28 is connected to a MeNB 29. Based on the knowledge of the capabilities and/or the UE context of the wireless device 28, the MeNB 11 has completed configured NR measurement objects for the wireless device 28. Furthermore, in the example scenario, the wireless device 28 is configured by the MeNB 29 with a low B1 threshold value and/or a low B1 time to trigger evaluation period, thereby allowing for many opportunities for the wireless device 28 to attach to nearby NR cells. The wireless device 28 measures the frequencies that it has been configured with, and upon any measurement value fulfilling the B1 threshold for the duration of the configured B1 time to trigger, the wireless device sends 39 a measurement report comprising measurement values, e.g. B1 measurements, and a physical cell identity, PCI, of a candidate NR cell to the MeNB 29.

The MeNB 29 then determines which cell is the most suitable cell to serve as a secondary cell, e.g. among a plurality of NR cells which respective B1 measurement all passed the B1 threshold If the NR PCI of the NR cell is known, the MeNB 29 selects the reported NR cell as a target to setup EN-DC with the wireless device 28. The MeNB 29 have the capacity to identify a gNB 30 that serves the NR cell based on the cell's reported PCI.

The MeNB 29 then identifies that the gNB 30 provides the target NR cell, and sends 40 an SgNB addition request over the X2 interface to the gNB 30 to setup the gNB 30 as a secondary node. If the gNB 30 accepts to be a secondary node, it allocates resources and responds 41 to the MeNB 29 with an SgNB addition acknowledgement. The acknowledgement may relate to providing information of how to random access to the first NR cell, e.g. RACH-configure on PSCell.

The MeNB 29 sends 42 an RRC reconfigure message to the wireless device 28, to instruct the wireless device 28 to perform random access to the target NR cell.

The wireless device 28 applies a new RRC reconfiguration based on the RRC connection reconfiguration message and replies 43 to the MeNB 29 with an RRC reconfigure complete message to the MeNB 29. The MeNB 29 then informs 44 the gNB 30 that the wireless device 28 has completed the reconfiguration procedure by sending an RRC reconfigure complete message over X2 to the selected gNB 30. At this point, the RAN state may be declared as being NR EN-DC configured and the wireless device 28 may now attempt to attach to the NR cell of the selected gNB 12.

The wireless device 28 may now start to perform 46 random access towards the gNB 30. However, as the wireless device 28 has been configured with a low B1 threshold, the radio signal quality between the wireless device 28 and the gNB 30 may be poor and e.g. the signal quality may only fulfil a minimum requirement of being able to sustain a connection. Hence, in this scenario, the random access attempt towards the target NR cell fails, e.g. as the NR uplink between the wireless device 28 and the target NR cell may have poor UL radio quality resulting in the random access failure. This may be since the preamble and/or other messages of the random access procedure sent from the wireless device 28 was not able to be received by the gNB 30.

Random access may then continue to be attempted until succeeding or until a maximum amount of time has elapsed, or a maximum number of attempts have been reached.

If random access still have not been succeeded, the connection between the wireless device 28 and the gNB 30 has failed to setup. The wireless device 28 then declares failure by sending 47 failure information to the MeNB 29. The MeNB 29 then determines that the random access from the wireless device 28 to the gNB 30 has failed.

The wireless device 28 reverts back to performing B1 measurements for new B1 events as initially configured by the MeNB 29.

In other scenarios, the wireless device 28 would be configured with a B1 threshold corresponding to a higher quality radio signal, such that the wireless device 28 would then be likely to perform B1 measurements until finding a new NR cell to attach to, in which case, attaching to that NR cell would be likely to succeed.

However, as the B1 threshold is now set to be relatively low, the wireless device 29 is now likely to measure a new B1 measurement value for the same cell again, e.g. the target cell of the gNB 30. A new B1 measurement of the target cell still fulfils the B1 threshold, and causes a new B1 event. The MeNB 29 will reconfigure the gNB 30 and the wireless device 28 again for them to attempt to setup EN-DC. The wireless device 28 will then attempt to initiate random access to the gNB 30 again. This will however again fail as the radio condition is still not good enough to sustain a connection between the wireless device 28 and the gNB 30. In other words, the wireless device 28 and the gNB 30 may now be stuck in a race around condition, wastefully iteratively repeating the signalling of steps 32 to 48 above without being able to setup EN-DC.

Examples of embodiments herein e.g. provide an adaptive threshold for setting up a secondary cell connection. Some embodiments herein may more specifically relate to any one or more of: NR NSA, EN-DC, NR RACH attempts, SCG failures, NR B1 measurements and B1 threshold values.

As mentioned above, an object of embodiments herein is thus to improve resource management of setting up a connection to a secondary cell, e.g. configuring NR connectivity. This is in some embodiments performed by e.g. by detecting the probability of a race-around condition for NR RACH failure in the stage of NR NSA EN-DC leg setup and to mitigate it by avoiding repeated B1 measuring and random access. A race-around condition when used herein means a continuous loop of failure, e.g. where it may not be possible to resolve the situation. This may be performed by configuring a random access failing wireless device with an adapted B1 threshold. In some scenarios embodiments also may relate to configuring the wireless device with an adapted time to trigger evaluation timer. In scenarios where further race-around conditions are detected, the B1 threshold and B1 time to trigger may e.g. be adapted iteratively, demanding higher radio quality for the B1 event upon each failed attempt to set up an EN-DC connectivity with a target secondary cell, until succeeding a random access to the secondary cell.

The embodiments herein may thus save significant optimization effort in configuring a suitable the B1 event threshold and save energy and computational resources by reducing the number of failed random access attempts and avoiding the race-around condition. Embodiments herein e.g. enable an automatic parametric optimization for coverage and radio quality as it is possible to start with a wide NR coverage, and have the threshold value adapted to a suitable radio quality when detecting failures. The embodiments herein may be particularly concerned with EN-DC and B1 thresholds, but may also apply to any network utilizing a secondary cell, e.g. applicable for both 5G NSA and SA deployment and may also be deployed for in 5G Self-Organizing Networks (SON).

Furthermore, embodiments herein may improve a random access success rate, and may thus reduce the amount of time to setup, or switch to, a secondary cell, e.g. an NR leg setup, by reducing the number of random access failures, e.g. NR RACH failures during an EN-DC configuration. This further may improve control plane latency since random access success may be achieved quicker.

Furthermore, embodiments herein may also relate to simplifying connecting to a cell in an NR NSA 5G high density rollout scenarios since the NR access coverage area may be made larger while avoiding a larger number of failures to setup secondary cells.

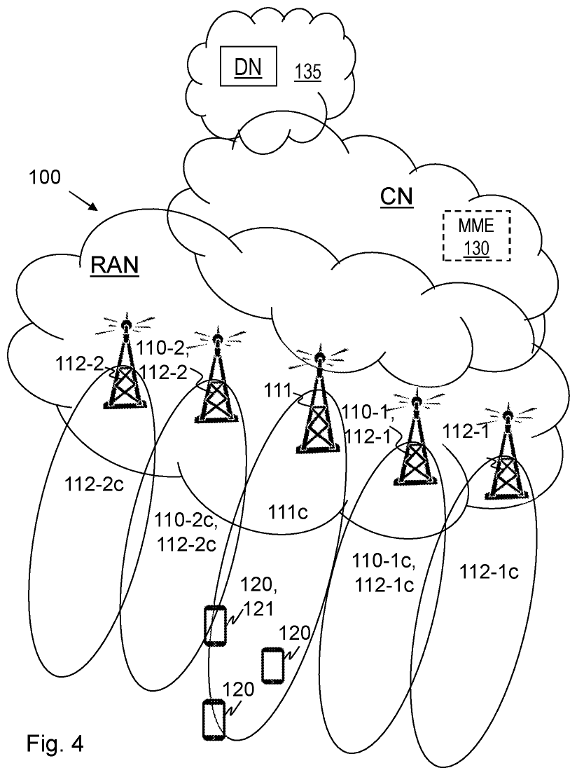

FIG. 4 is a schematic overview depicting a wireless communications network 100 wherein embodiments herein may be implemented. The wireless communications network 100 comprises one or more RANs and one or more CNs. The wireless communications network 100 may use a number of different technologies, such as LTE, LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations.

A number of network nodes operate in the wireless communications network 100 such as e.g. a first network node 111 and one or more network nodes 110-1, 112-1 one or more network nodes 110-2, 112-2. These nodes provide radio coverage in a number of cells which may also be referred to as a beam or a beam group of beams, such as a first cell 111c, secondary cell candidates 110-1c, 112-1c, and second secondary cell candidates 110-2c, 112-2c. The first network node 111 provides the first cell 111c which may be a primary cell. The first network node 111 may also provide any one or more out of cells the secondary cell candidates 110-1c, 112-1c, 110-2c, 112-2c. The first network node 111 may e.g. be an MeNB when serving a wireless devices 120, 121 in the wireless communications network 100, according to embodiments herein.

The secondary cell candidates 110-1c, 112-1c may also be provided by the one or more network nodes 110-1, 112-1. The one or more network nodes 110-1, 112-1, may be SgNBs when serving wireless devices 120, 121 in the wireless communications network 100. Similarly, the second secondary cell candidates 110-2c, 112-2c may also be provided by the one or more network nodes 110-2, 112-2. The one or more network nodes 110-2, 112-2, may be SgNBs when serving a wireless device 120, 121 in the wireless communications network 100. In some embodiments, the one or more network nodes 110-1, 112-1 may comprise all or part of the one or more network nodes 110-2, 112-2. The one or more network nodes 110-1, 112-1, and/or the one or more network nodes 110-2, 112-2 may in some embodiments be the first network node 111. In other words, any one or more primary cell and/or secondary cell in embodiments herein may be provided by the first network node 111, but may alternatively be provided by the respective other network nodes 110-1, 112-1, 110-2, 112-2.

The first network node 111, the one or more network nodes 110-1, 112-1, and the one or more network nodes 110-2, 112-2 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless device within the service area served by each respective network node 111, 110-1, 112-1, 110-2, 112-2 depending e.g. on the first radio access technology and terminology used.

The first network node 111 may be referred to as a serving radio network node and communicates with a group of wireless devices 120, 121, e.g. a first wireless device 121, with Downlink (DL) transmissions to the group of wireless devices 120, 121 and Uplink (UL) transmissions from the group of wireless devices 120, 121.

In the wireless communication network 100, one or more wireless devices operate, such as e.g. the group of wireless devices 120, 121 comprising the first wireless device 121 and possibly one or more other wireless devices 120. The group of wireless devices 120, 121, also referred to as devices, IoT devices, mobile stations, non-access point (non-AP) STAs, STAs, UEs and/or wireless terminals, communicate via one or more Access Networks (AN), e.g. RAN, to one or more core networks (CN). It should be understood by the skilled in the art that “wireless device” is a non-limiting term which means any terminal, wireless communication terminal, UE, Machine Type Communication (MTC) device, Device to Device (D2D) terminal, or node e.g. smart phone, laptop, mobile phone, sensor, relay, mobile tablets or even a small base station communicating within a cell.

In the wireless communication network 100, one or more MMEs may operate, such as e.g. an MME 130. The MME 130 may be connected to the network node 111 and may be configured to provide control plane functionalities to the wireless device 121, e.g. an initial context setup procedure.

Methods herein may be performed by the first network node 111. As an alternative, a Distributed Node (DN) and functionality, e.g. comprised in a cloud 135 as shown in FIG. 4, may be used for performing or partly performing the methods herein, e.g. implemented as a Control Plane (CP) function.

A number of embodiments will now be described, some of which may be seen as alternatives, while some may be used in combination.

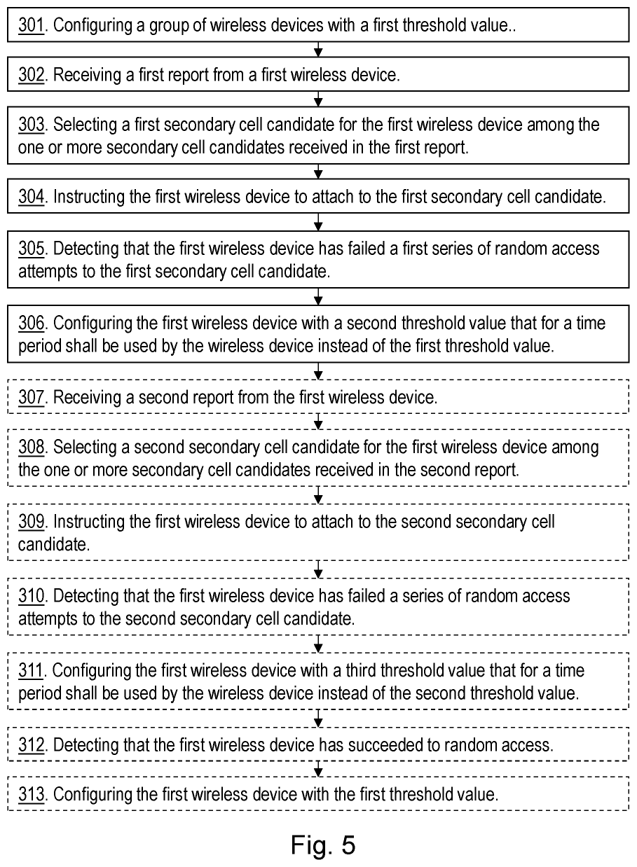

FIG. 5 shows example embodiments of a method performed by the first network node 111 for selecting the first secondary cell 112-1c for supporting split bearer mode with the first wireless device 121 in the wireless communications network 100. The first wireless device 121 is one in the group of wireless devices 120, 121 for which the first cell 111c provided by the first network node 111 acts as a primary cell. The group of wireless devices 120, 121 are configured to measure the signal quality of the secondary cell candidates 110-1c, 112-1c. The method comprises the following actions, which actions may be taken in any suitable order. Optional actions are referred to as dashed boxes in FIG. 5.

In an example scenario herein, selecting the first secondary cell 112-c for supporting a split-bearer mode may relate to selecting a secondary cell for Dual Connectivity, e.g. EN-DC, wherein the first cell 111c is the cell in which the wireless device 121 is attached and that may be an LTE cell, and the first secondary cell 112-1c is a candidate cell for providing a secondary connectivity in addition to that of the first cell, and the secondary cell candidates 110-1c, 112-1c may be NR cells. It is the first network node 111 providing the first cell 111c that configures the group of wireless devices 120, 121 for reporting measurements of neighbour cells. The frequencies and technologies to measure and/or report is determined by the first network node 111 based on wireless devices capabilities, as is defined in the UE context.

Action 301

The first network node 111 configures the group of wireless devices 120, 121 with a first threshold value relating to a measured signal quality for determining whether any secondary cell candidate/s 110-1c, 112-1c shall be reported to the first network node 111.

In this way, a first threshold value, e.g. a common first threshold value, may be configured for all wireless devices in the group of wireless devices 120, 121, associated with a specific cell. The specific cell may e.g. be the first cell 111c. The first threshold value may e.g. a B1 threshold value.

In some embodiments, the first threshold value may serve as an initial threshold value e.g. to use when performing first B1 measurements when connected to the first cell 111c.

Action 302

The first network node 111 receives a first report from the first wireless device 121. The first report comprises a measured signal quality for a respective one or more secondary cell candidate 110-1c, 112-1c whose measured signal quality meets the first threshold.

Meeting the first threshold may in some embodiments relate to that the measured signal quality for a respective one or more secondary cell candidate 110-1c, 112-1c is meeting the first threshold for a certain evaluation period, e.g. during a B1 time to trigger value. In other words, the first report may indicate which secondary candidate cells 110-1c, 112-1c may be used as secondary cells e.g. in EN-DC, and may comprise their respective B1 measurement fulfilling the first threshold.

In some embodiments the first report comprises any one out of:
A received RSRP value,
a received RSRQ value, and
a received SINR value.

In this way, the first report may comprise a value best suited for the characteristics of the wireless communications network 100.

Action 303

The network node 111 selects, for the first wireless device 121, among the one or more secondary cell candidates 110-1c, 112-1c as is/are received in the first report, a first secondary cell candidate 112-1c, based on the first report.

The network node 111 may thus select the most suited cell to be the first secondary cell candidate 112-1c, e.g. the cell among the secondary cell candidates 110-1c, 112-1c with the best signal quality according to the first report. Selecting the first secondary cell candidate 112-1c may in some embodiments involve sending an SgNB addition request to a network node serving the first secondary cell candidate 112-1c.

Action 304

The first network node 111 instructs the first wireless device 121 to attach to the first secondary cell candidate 112-1c. This may be performed by sending a message to the first wireless device 121, e.g. an RRC reconfiguration message. Due to this instruction, the wireless device 121 may be triggered to initiate a random access procedure to the first secondary cell candidate 112-1c, to attach to the first secondary cell candidate 112-1c.

Action 305

The first network node 111 detects that the first wireless device 121 has failed a first series of random access attempts to the first secondary cell candidate 112-1c. This may in some embodiments be detected by receiving a failure message, e.g. SCG failure information message, from the wireless device 121 comprising information about the failure. The series of random access attempts may be one or more random access procedures, e.g. contention based or contention free random access. The one or more random access procedures may be bounded by a maximum amount of time configured by the first network node 111 e.g. by use of a timer. The one or more random access procedures may additionally be bounded by a maximum number of random access attempts configured by the first network node 111.

Action 306

In response to detecting that the first wireless device 121 has failed the first series of random access attempt to the first secondary cell candidate 112-1c, the first network node 111 configures the first wireless device 121 with a second threshold value. The second threshold value shall for a time period be used by the wireless device 121 instead of the first threshold value for determining whether any secondary cell candidate/s 110-1c, 112-1c shall be reported to the first network node 111. The second threshold value relates to a better signal quality than the first threshold value.

In response to determining that the wireless device 121 has failed to attach to the first secondary cell candidate 112-1c, through the first series of random access attempts, the first threshold value is replaced with the second threshold value to be used by the wireless device 121 during a time period. The second threshold value requires better quality of a cell candidate to be reported by the wireless device. The first network node 111 may in this way improve the chances of succeeding any subsequent attempt to access a secondary cell that is selected according to the second threshold value. After the time period has ended, the wireless device 121 may again use the first threshold value.

In some embodiments the better signal quality comprises any one or more out of:
A stronger signal strength,
a higher Signal-to-Noise and Interference Ratio, e.g. how well the signal is perceived in relation to interference, and
a longer evaluation period, e.g. an increased B1 time to trigger value.

In some embodiments the period of time that the second threshold shall be used by the wireless device 121 relates to any one out of:
A predetermined time,
a successful random access attempt, and
a failed series of random access attempts.

The first threshold value may then in some embodiments be a default threshold value of the first cell 111c, and the second threshold value may be used temporarily for the wireless device 121 e.g. for filtering out poor candidate cells when trying to select a secondary cell for split bearer mode, and may then e.g. after the period of time, be reverted back to the first threshold value.

Action 307

In some embodiments the first network node 111 receives a second report from the first wireless device 121. The second report comprises a measured signal quality of the respective one or more secondary cell candidate 110-2c, 112-2c whose measured signal quality meets the second threshold. The first wireless device 121 may now have performed new measurements and reports signal qualities of the secondary cell candidates 110-2c, 112-2c that are meeting the second threshold.

In this way, the first network node 111 may now have a second set of secondary cell candidates 110-2c, 112-2c, e.g. comprising all or part of the secondary cell candidates 110-1c, 112-1c associated with the first report. The second cell candidates 110-2c, 112-2c, may also, e.g. due to mobility, comprise e.g. partly or solely, cell candidates not associated with the first report.

Action 308

In some embodiments, the first network node 111 selects a second secondary cell candidate 112-2c for the first wireless device 121. The second secondary cell candidate 112-2c, is selected among the one or more secondary cell candidates 110-2c, 112-2c as is/are received in the second report, based on the second report.

The network node 111 may thus select the most suited cell to be the second secondary cell candidate 112-2c, e.g. the cell among the secondary cell candidates 110-2c, 112-2c with the best measured signal quality in the second report. In this way, the second secondary cell candidate 112-2c may be associated with the best signal quality according to the second report. Furthermore, as the second threshold value may relate to a better signal quality than the first threshold value, the measured signal quality of the second secondary cell candidate 112-2c may in this way be of better quality than the measured signal quality of the first secondary cell candidate 112-1c.

Selecting the first secondary cell candidate 112-1c may in some embodiments involve sending an SgNB addition request to a network node serving the first secondary cell candidate 112-1c.

Action 309

In some embodiments the first network node 111 instructs the first wireless device 121 to attach to the second secondary cell candidate 112-2c. This may be performed by sending a message to the first wireless device 121, e.g. an RRC reconfiguration message. Due to this instruction, the wireless device 121 may be triggered to attempt random access to the second secondary cell candidate 112-2c, e.g. to start a series of random access attempts to the second secondary cell candidate 112-2c. The series of random access attempts may be one or more random access attempts, e.g. configured and bounded similar to action 305 above.

Action 310

In some embodiments, the first network node 111 detects that the first wireless device 121 has failed the series of random access attempts to the second secondary cell candidate 112-2c. This may in some embodiments be detected by receiving a failure message, e.g. SCG failure information message, from the wireless device 121 comprising information about the failure.

Action 311

In some of these embodiments, in response to detecting that the first wireless device 121 has failed the series of first random access attempts to the second secondary cell candidate 112-2c, the first network node 111 configures the first wireless device 121. The first network node 111 configures the first wireless device 121 with a third threshold value that for a time period shall be used by the wireless device 121 instead of the second threshold value for determining whether any secondary cell candidate/s 110-2c, 112-2c shall be reported to the first network node 111. The third threshold value relates to a better signal quality than the second threshold value.

In this way, when the wireless device 121 fails the series of random access attempts when configured with a second threshold value, the second threshold may be replaced with the third threshold value for the wireless device 121 to filter out poor quality cell candidates, and may thus further improve chances for random access success to future selected cell candidates.

In some embodiments, this may further be an iterative process, wherein for each iteration, the configured threshold value needs to be replaced with a new threshold value relating to a better signal quality for every iteration. In other words, this process may continue in a similar manner when detecting failure of a series of random access attempts e.g. by replacing the current configured threshold value, with a threshold value relating to better signal quality than the current threshold value. In this way, the process may converge towards a threshold value relating to a high quality measured signal quality and thus be associated with high chances of random access success.

Action 312

In some embodiments, the first network node 111 detects that the first wireless device 121 has succeeded to random access any of the secondary cell candidates 110-2c, 112-2c. This may be since, in some scenarios, the quality of the secondary cell candidates 110-2c, 112-2c may have improved when using the second threshold value, and thus the secondary cell candidates 110-2c, 112-2c may now relate to high quality measured signal quality.

Action 313

In some of these embodiments, in response to detecting that the first wireless device 121 has succeeded to random access any of the secondary cell candidates 110-2c, 112-2c, the first network node 111 configures the first wireless device 121 with the first threshold value. The wireless device 121 may in this way may stop using a temporary threshold, e.g. second threshold value or third threshold value, and revert back to the first threshold. In this way, the wireless device 121 will use the first threshold e.g. when selecting a new secondary cell.

In some embodiments, the first wireless device 121 comprises two or more wireless devices 121. The two or more wireless devices 121 may constitute the group or part of the group of wireless devices 120, 121 and may be configured with the first threshold value and instructed concurrently according to embodiments herein.

In some embodiments, any of the e.g. following actions are part of, or based on, a RRC procedure e.g. by sending an RRC Reconfigure message:
Configuring the group of wireless devices 120, 121, e.g. as in action 301 above,
receiving from the first wireless device 121, the first report, e.g. as in action 302 above,
selecting, for the first wireless device 121, among the one or more secondary cell candidates 110-1c, 112-1c, e.g. as in action 303 above,
instructing the first wireless device 121 to attach to the first secondary cell candidate 112-1c, e.g. as in action 304 above,
detecting that the first wireless device 121 has failed the first series of random access attempts to the first secondary cell candidate 112-1c, e.g. as in action 305 above, and
configuring the first wireless device 121, e.g. as action 306 above.

Furthermore, any other action, e.g. any of actions 307-313 above, may also be part of, or based on an RRC procedure, e.g. by sending an RRC reconfigure message.

The above discussed embodiments will now be further explained and exemplified below. The embodiments below may be combined with any suitable embodiment above.

In some example scenarios, to maximize coverage area of NR, without compromising setup success rate and a fast NR leg set up time, a common first threshold value, e.g. for B1 using RSRP, may be −130 dBm or lower.

This may be particularly suitable for an NR NSA scenario e.g. to extend NR access coverage. However, in these scenarios, power for a DL connection may be restricted, e.g. due to a regulatory instruction. Hence, when there is a DL connection with low RSRP, a corresponding UL connection may have high interference or poor UL pathloss, e.g. making the UL connection too poor to maintain.

In these scenarios, embodiments herein may thus enable a way to provide a high EN-DC setup success rate and a fast NR leg set up time. A such example is illustrated in FIG. 6 and will be described in further detail according to an example scenario of FIG. 6.

The MME 130 may send 501 an initial context setup request to the first network node 111. The first network node 111 then sets up a UE context for the wireless device 121 comprising the capabilities of the wireless device 121. The capabilities may comprise the capability to have connectivity with more than one cell, what combination of carrier frequencies and combination of LTE, NR and possible any 6G based technology of the cells providing the connectivity.

Based on the UE context of the wireless device 121, the first network node 111, determines how to configure the wireless device 121, and further transmits 502 an RRC Reconfiguration message to the wireless device 121, in which it configures the wireless device 121 on how the wireless device 121 shall measure and report cells, both on the frequencies it is served and on other frequencies, possibly involving cells of other technologies than that of the first cell. This configuration is made by a RRC reconfiguration message if the first network node is an LTE node. This may relate to configuring the group of wireless devices 120, 121 with the first threshold value, e.g. as in action 301 above.

The first network node 111 then responds 503 to the MME 130 with an initial context setup response, informing the MME 130 that the UE context is setup.

Upon being RRC configured the wireless device 121 starts measuring on cells of the other frequencies and technologies, e.g. performing B1 measurements. When measurement values of at least one cell fulfils the B1 threshold, the wireless device 121 reports 504 the at least one cell's measurement value, e.g. B1 measurement value, and the PCI identifying the at least one cell to the first network node 111. The at least one cell's measurement value is reported in a measurement report, and may be associated with the best measured signal quality, e.g. RSRP value. This may relate to receiving a first report, e.g. as in action 302 above.

The first network node 111 then selects the most suitable cell from to be the first secondary cell candidate 112-1c, e.g. based on the at least one cell's measurement value, and identifies the secondary network node that serves the suitable cell based on the PCI. The first network node 111 sends 505 a request to the first network node 111 to serve the wireless device 121 in the cell of the PCI. This may be by an SgNB addition request to the secondary network node, e.g. the network node 112-1, serving the first secondary candidate cell 112-1c. The request may be sent over the X2 interface. This may relate to action 303 above.

On condition that the secondary network node, e.g. the network node 112-1, accepts the request, it sends 506 an acknowledgement to the first network node 111. The acknowledgement may be sent over the X2 interface.

Upon receipt of the acknowledgement from the secondary network node, the first network node 111 sends 507, an instruction to the wireless device 121 to attach to the first secondary candidate cell 112-1c. The instruction is sent by an RRC reconfiguration message.

In response to the instruction received from the first network node the wireless device 121 applies a new RRC reconfiguration based on the RRC connection reconfiguration message and replies 508 to the MeNB 11 with an RRC reconfiguration complete message. The first network node 111 then sends 509, e.g. over the X2 interface, a notification of the wireless device 121 completing the reconfiguration procedure successfully, e.g. as an RRC reconfiguration complete message. At this point, the RAN state may be declared as being NR EN-DC configured and the wireless device 121 may now attempt to attach to the first secondary candidate cell 112-1c.

Random access may then be attempted 510 by the wireless device 121 to the secondary candidate cell 112-1c, a until a timer expires or a maximum number of attempts is reached. The timer may e.g. be a T304 timer may start at an RRC reconfiguration, e.g. including reconfiguration with synchronization, and may stop when succeeding to random access, e.g. NR RACH success. The timer may be executed in the wireless device 121 and may e.g. expire when a configured, or predefined amount of time has passed, e.g. 1000 ms. The maximum number of attempts may be specified according to a system configuration, e.g. 10 times. The maximum number of attempts may be predefined.

The UL connection may now be power limited and/or UL pathloss to the first secondary candidate cell 112-1c may high. In this way, a series of random access attempts from the wireless device 121, e.g. NR RACH, to the secondary network node, may fail. The failure may further generate a cause code, e.g. FAILURE_MSG2_RACH_Timer_Expiry or RACH Aborted, which may be sent to the first network node 111. This may relate to action 305 above.

The wireless device 121 sends 511 failure information to the first network node 111. The failure information may comprise a reason why the wireless device 121 is unable to random access the secondary network node. The failure information may comprise information regarding a measurement result for failure to first secondary candidate cell 112-1c, e.g. the associated PCI in a specified SSB index along with RSRP, RSRQ and/or SINR value. The first network node 111 may also be informed of the wireless device 121 failure, e.g. as token information in an LTE RRC message from wireless device 121 comprising failure information and a failure type, e.g. as a message comprising c2: SCG Failure Information NR-r15: failureType-r15 Random Access Problem.

The first network node 111 detects a first series of random access failures, e.g. NR RACH failures. The first network node 111 may start an internal failure timer. The internal failure timer may be operator configurable, and may e.g. be a Managed Object Model (MOM) parameter. The first network node 111 may also configure e.g. a failure threshold value. The failure threshold value may e.g. be an operator configurable MOM parameter.

The internal failure timer and the failure threshold value may then be used to further limit the amount of time and/or the number of attempts performing repeated series of random access after failing to attach to the first secondary candidate cell 112-1c. This may be to reduce the number of random access failures in a series of random access attempts, and e.g. faster find a suitable secondary cell candidate with sufficiently high signal quality. Instead of spending time in performing series of random access failures, the first network node 111 may perform fewer random access attempts, and instead adapt the current threshold value, e.g. first threshold value, thus providing better quality candidate cells for future random access attempts which the wireless device 121 have better chances to attach to.

The first network node 111 then e.g. releases the secondary network node, and determines 512 a second threshold value, e.g. a new B1 threshold. The second threshold value may be calculated by the first network node 111 based on e.g. internal counters. This may relate to action 306.

The first network node 111 may further track previously measured signal qualities and record if, and how many times they may have resulted in a random access success or series of random access failures. The tracked previously measured signal qualities may thus comprise e.g. the lowest and/or most recent RSRP at which NR RACH was successful. The first network node 111 may then, if available, calculate the second threshold value based on the tracked previously measured signal qualities and will be further explained below.

As an example, the first threshold value may be configured to relate to a 130 dBm RSRP value, e.g. measurements must exceed the first threshold value to be considered to be a secondary candidate cell. Furthermore, when using the first threshold value, the secondary candidate cell may have provided a series of random access failures. The first network node 111 may then determine the new threshold value, e.g. the second threshold value, to be 122 dBm, e.g. as 122 dBm has been previously tracked and is associated with a previous successful random access attempt. Further, if the evaluation period of the first threshold value, e.g. a B1 time to trigger, is 40 milliseconds (ms), the second threshold value may be two times the first threshold value, e.g. 80 ms. In this way, the number of transmitted measurement reports, e.g. B1 events, is reduced e.g. when future attempts to attach to a secondary candidate cell occurs. In some embodiments, the evaluation period may e.g. be any one out of the following values: 0, 40, 64, 80, 100, 128, 160, 256, 320, 480, 512, 640, 1024, 1280, 2560, 5120.

When there are no tracked previously measured signal qualities associated with a successful random access, the second threshold value may be based on a predetermined adjustment to the first threshold value. E.g. the second threshold value may be the first threshold value with an addition of 3 dB for each iteration if the process continues. E.g. second threshold value=first threshold value+3 dB, third threshold value=second threshold value+3 dB, etc.

Similarly an evaluation period may be twice as long per each iteration. E.g. second threshold value=first threshold value*2 ms, third threshold value=second threshold value*2 ms.

The first network node 111 may then send 513 an instruction to the wireless device 121 to use the second threshold value instead of the first threshold value, e.g. by sending an RRC reconfiguration message which may comprise a modified B1 threshold and a new B1 time to trigger value.

The wireless device 121 performs new measurements using the second threshold value and provide a new measurement report, e.g. the second report, to the first network node 111, e.g. relating to secondary candidate cells 110-2c, 112-2c. The first network node 111 e.g. tries to instruct the wireless device 121 to attach to a second secondary candidate cell 112-2c.

The first network node 111 detects 514 whether or not a successful random access from the wireless device 121 to the second secondary candidate cell 112-2c, has occurred. E.g. if there has been a successful RRC reconfiguration and NR RACH success.

In some scenarios, the first network node 111 detects 515a a series of random access attempts from the wireless device 121 to the second secondary candidate cell 112-2c have failed. The first network node 111 may then continue iteratively to replace threshold values with threshold values relating to better quality, until detecting a successful random access.

In some other scenarios, the first network node 111 detects 515b a successful random access success to the secondary candidate cell 112-2c. The first network node 111 may then update its previously tracked measured signal qualities to include the successful random access. The data session, e.g. NR data session, using the secondary cell candidate 112-2c may then start. After the date session completes, the first network node 111 may then revert back to use the first threshold value, e.g. initial B1 threshold and initial B1 time to trigger value, for good access coverage.

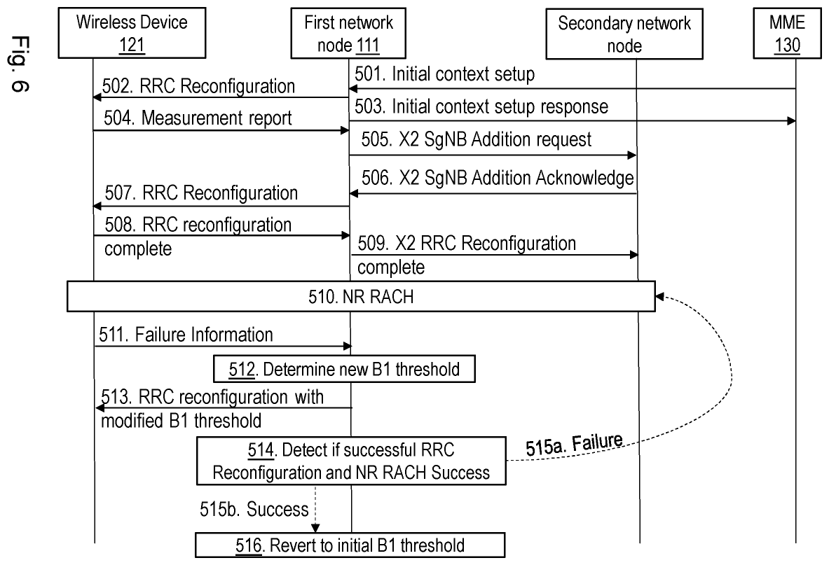

A diagram of FIG. 7 illustrates contents of the tracked measured signal qualities referred to above. The X-axis represents a specific measured RSRP value, e.g. sent to the first network node 111 by the wireless device 121. This may relate to the measured signal quality of the first report in action 302 above. The Y-axis represents the number of sessions the RSRP, e.g. number of times, the corresponding RSRP value has led to a random access success, e.g. as in action 312 above, and/or a series of random access failure, e.g. as in action 305 or 310 above.

The measured signal qualities may refer to previous measured signal qualities in and the number of successful or in subsequent random access attempts. The tracked measures signal qualities may e.g. be received in the first or second report from the group of wireless devices 120, 121 and/or the wireless device 121. The tracked measured signal qualities may be stored in a matrix in the first network node 111. X in FIG. 7 indicates an amount of successful random access attempts using a certain RSRP value and boxes, □, in FIG. 7 indicates failed series of random access attempts using a certain RSRP value. In embodiments herein, the first network node 111 may determine an adjusted threshold value, e.g. the second threshold value, based on the number of random access successes and/or failures. In some embodiments the first network node 111 may use any of the tracked values, e.g. highest or lowest, as a threshold value. The first network node 111 may further also use any statistical derivation of the values, e.g. median or average RSRP of successful attempts, as a threshold value.

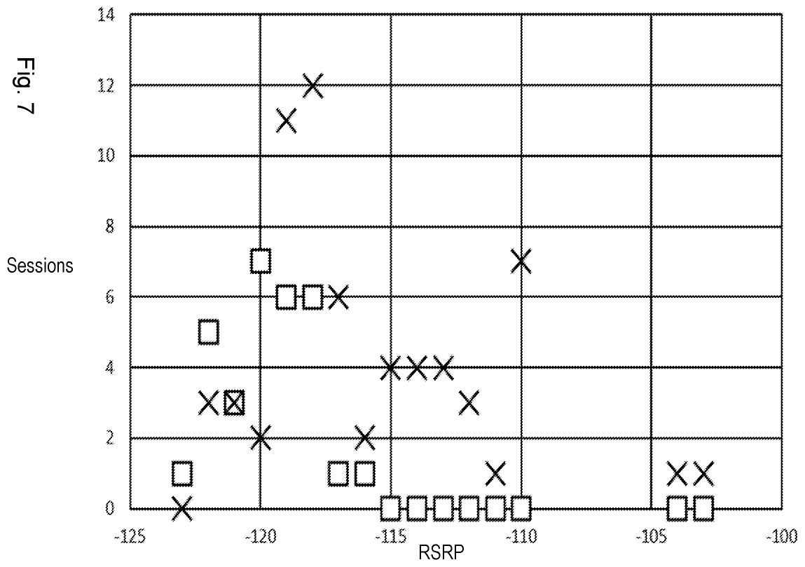

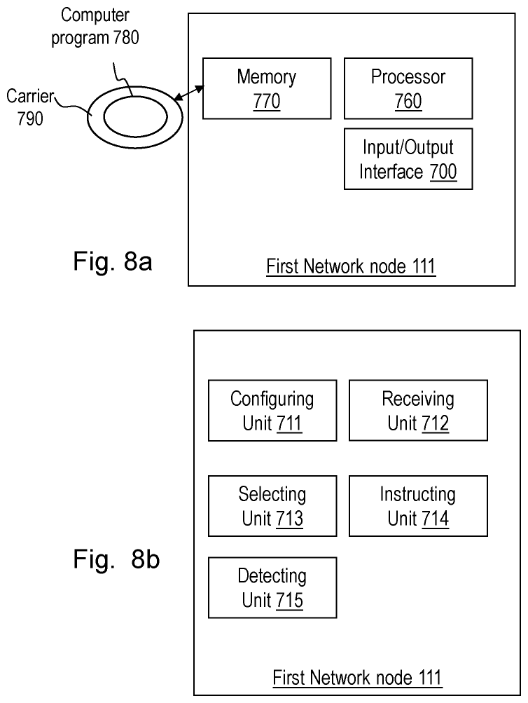

To perform the method actions above, the first network node 111 is configured to select a first secondary cell 112-1c for supporting split bearer mode with the first wireless device 121 in a wireless communications network 100. The first wireless device 121 is arranged to be one in the group of wireless devices 120, 121 for which the first cell 111c provided by the first network node 111 acts as a primary cell. The group of wireless devices 120, 121 are adapted to be configured to measure the signal quality of secondary cell candidates 110-1c, 112-1c. The first network node 111 may comprise an arrangement depicted in FIGS. 8a and 8b.

The first network node 111 may comprise an input and output interface 700 configured to communicate with network nodes such as e.g. the wireless devices 120, 121 and the network nodes 110-1, 112-1, 110-2, 112-2. The input and output interface 700 may comprise a wireless receiver (not shown) and a wireless transmitter (not shown).

The first network node 111 may further be configured to, e.g. by means of a configuring unit 711 in the first network node 111, configure the group of wireless devices 120, 121 with a first threshold value relating to a measured signal quality for determining whether any secondary cell candidate/s 110-1c, 112-1c shall be reported to the first network node 111.

The first network node 111 may further be configured to, e.g. by means of a receiving unit 712 in the first network node 111, receive from the first wireless device 121, a first report comprising a measured signal quality for a respective one or more secondary cell candidate 110-1c, 112-1c whose measured signal quality is arranged to meet the first threshold.

The first network node 111 may further be configured to, e.g. by means of the receiving unit 712 in the first network node 111, receive from the first wireless device 121, a second report comprising a measured signal quality of a respective one or more secondary cell candidate 110-2c, 112-2c whose measured signal quality is arranged to meet the second threshold.

In some embodiments, the first report and/or second report may be adapted to comprise any one out of:
a received Reference Signal Received Power, RSRP, value,
a received Reference Signal Received Quality, RSRQ, value, and
a received Signal-to-Noise and Interference Ratio, SINR, value.

In some embodiments the period of time that the second threshold shall be used by the wireless device 121 may be adapted to relate to any one out of:
a predetermined time,
a successful random access attempt, and
a failed series of random access attempts.

The first network node 111 may further be configured to, e.g. by means of a selecting unit 713 in the first network node 111, select, for the first wireless device 121, among the one or more secondary cell candidates 110-1c, 112-1c as is/are arranged to be received in the first report, a first secondary cell candidate 112-1c, based on the first report.

The first network node 111 may further be configured to, e.g. by means of the selecting unit 713 in the first network node 111, select, for the first wireless device 121, among the one or more secondary cell candidates 110-2c, 112-2c as is/are arranged to be received in the second report, a second secondary cell candidate 112-2c based on the second report.

The first network node 111 may further be configured to, e.g. by means of an instructing unit 714 in the first network node 111, instruct the first wireless device 121 to attach to the first secondary cell candidate 112-1c.

The first network node 111 may further be configured to, e.g. by means of the instructing unit 714 in the first network node 111, instruct the first wireless device 121 to attach to the second secondary cell candidate 112-2c.

The first network node 111 may further be configured to, e.g. by means of a detecting unit 715 in the first network node 111, detect that the first wireless device 121 has failed a first series of random access attempts to the first secondary cell candidate 112-1c.

The first network node 111 may further be configured to, e.g. by means of the detecting unit 715 in the first network node 111, detect that the first wireless device 121 has failed the first series of random access attempts to the second secondary cell candidate 112-2c.

The first network node 111 may further be configured to, e.g. by means of the detecting unit 715 in the first network node 111, detect that the first wireless device 121 has succeeded to random access any of the secondary cell candidates 110-2c, 112-2c

The first network node 111 may further be configured to, e.g. by means of the configuring unit 711 in the first network node 111, in response to the detecting, configure the first wireless device 121 with a second threshold value that for a time period shall be used by the wireless device 121 instead of the first threshold value for determining whether any secondary cell candidate/s 110-1c, 112-1c shall be reported to the first network node 111, wherein the second threshold value is adapted to relate to a better signal quality than the first threshold value.

The first network node 111 may further be configured to, e.g. by means of the configuring unit 711 in the first network node 111, in response to the detecting, configure the first wireless device 121 with a third threshold value that for a time period shall be used by the wireless device 121 instead of the second threshold value for determining whether any secondary cell candidate/s 110-2c, 112-2c shall be reported to the first network node 111, wherein the third threshold value is adapted to relate to a better signal quality than the second threshold value.

The first network node 111 may further be configured to, e.g. by means of the configuring unit 711 in the first network node 111, in response to the detecting, configure the first wireless device 121 with the first threshold value.

In some embodiments the better signal quality may be adapted to comprise any one or more out of:
a stronger signal strength,
a higher Signal-to-Noise and Interference Ratio, SINR, and
a longer evaluation period.

In some embodiments the first wireless device 121 may be adapted to comprise two or more wireless devices 121.

In some embodiments, the network node 111 further is configured to any one or more out of:
configure the group of wireless devices 120, 121,
receive from the first wireless device 121, the first report,
select, for the first wireless device 121, among the one or more secondary cell candidates 110-1c, 112-1c,
instruct the first wireless device 121 to attach to the first secondary cell candidate 112-1c,
detect that the first wireless device 121 has failed the first series of random access attempts to the first secondary cell candidate 112-1c, and
configure the first wireless device 121,
as a part of, or based on, a RRC procedure.

The embodiments herein may be implemented through a respective processor or one or more processors, such as the processor 760 of a processing circuitry in the first network node 111 depicted in FIG. 8a, together with respective computer program code for performing the functions and actions of the embodiments herein. The program code mentioned above may also be provided as a computer program product, for instance in the form of a data carrier carrying computer program code for performing the embodiments herein when being loaded into the first network node 111. One such carrier may be in the form of a CD ROM disc. It is however feasible with other data carriers such as a memory stick. The computer program code may furthermore be provided as pure program code on a server and downloaded to the first network node 111.

The first network node 111 may further comprise a memory 770 comprising one or more memory units. The memory 770 comprises instructions executable by the processor in the first network node 111. The memory 770 is arranged to be used to store e.g. information, indications, data, configurations, thresholds, measurements, and applications to perform the methods herein when being executed in the first network node 111.

In some embodiments, a computer program 780 comprises instructions, which when executed by the respective at least one processor 760, cause the at least one processor of the first network node 111 to perform the actions above.

In some embodiments, a respective carrier 790 comprises the respective computer program 780, wherein the carrier 790 is one of an electronic signal, an optical signal, an electromagnetic signal, a magnetic signal, an electric signal, a radio signal, a microwave signal, or a computer-readable storage medium.

Those skilled in the art will appreciate that the units in the first network node 111 described above may refer to a combination of analog and digital circuits, and/or one or more processors configured with software and/or firmware, e.g. stored in the first network node 111, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

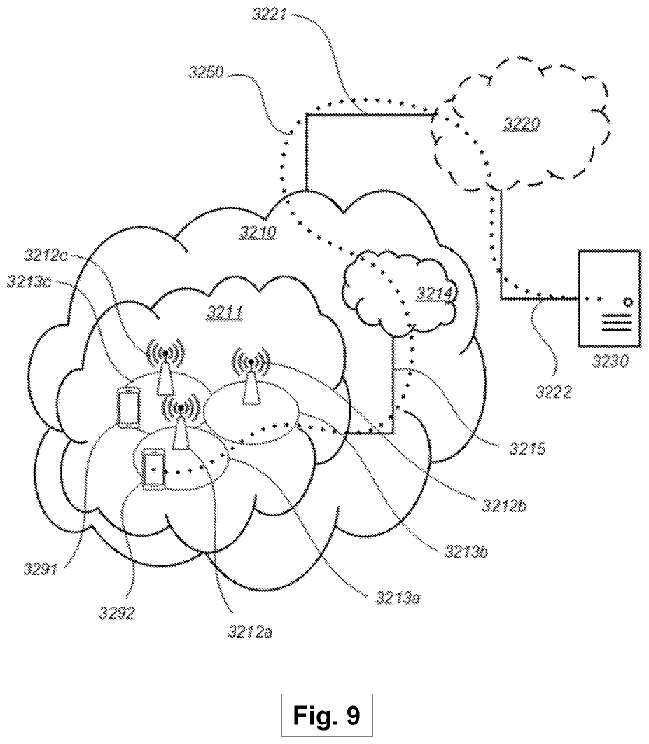

With reference to FIG. 9, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, e.g. the first network node 111, such as AP STAs NBs, eNBs, gNBs or other types of wireless access points, each defining a corresponding coverage area 3213a, 3213b, 3213c, e.g. any one or more out of cells 111c, 110-1c, 112-1c, 110-2c, 112-2c. Each base station 3212a, 3212b, 3212c is connectable to the core network 3214 over a wired or wireless connection 3215. A first user equipment (UE), e.g. wireless device 120, 121, such as a Non-AP STA 3291 located in coverage area 3213c is configured to wirelessly connect to, or be paged by, the corresponding base station 3212c. A second UE 3292, e.g. wireless device 120, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

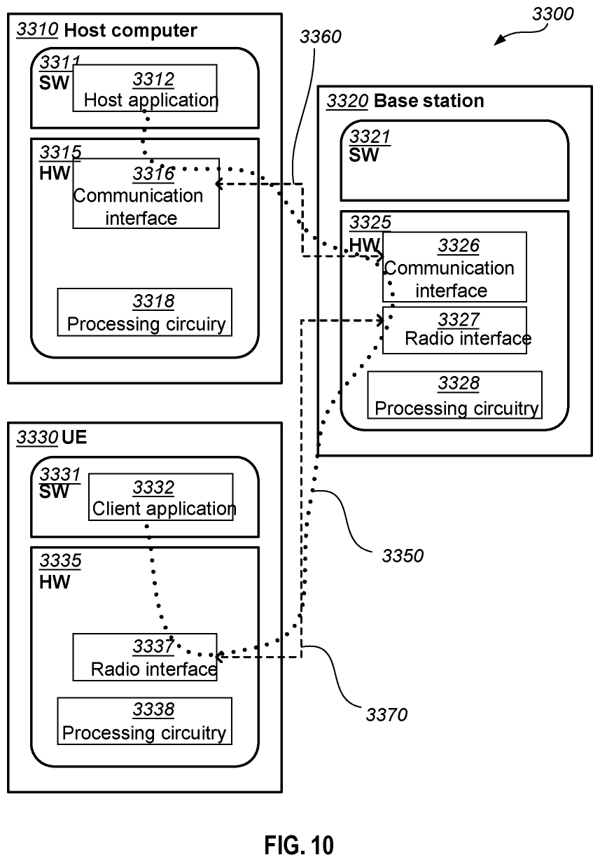

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

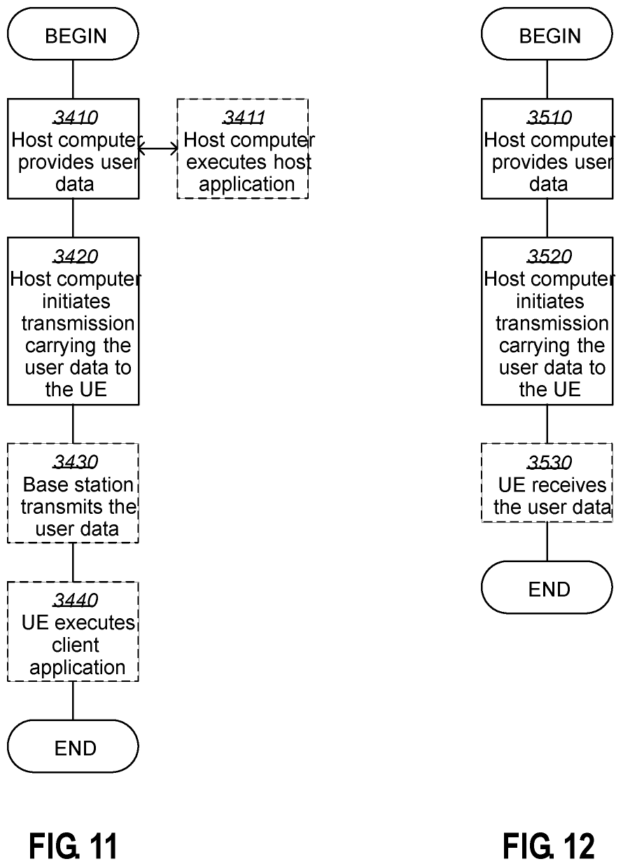

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, and/or power consumption, and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

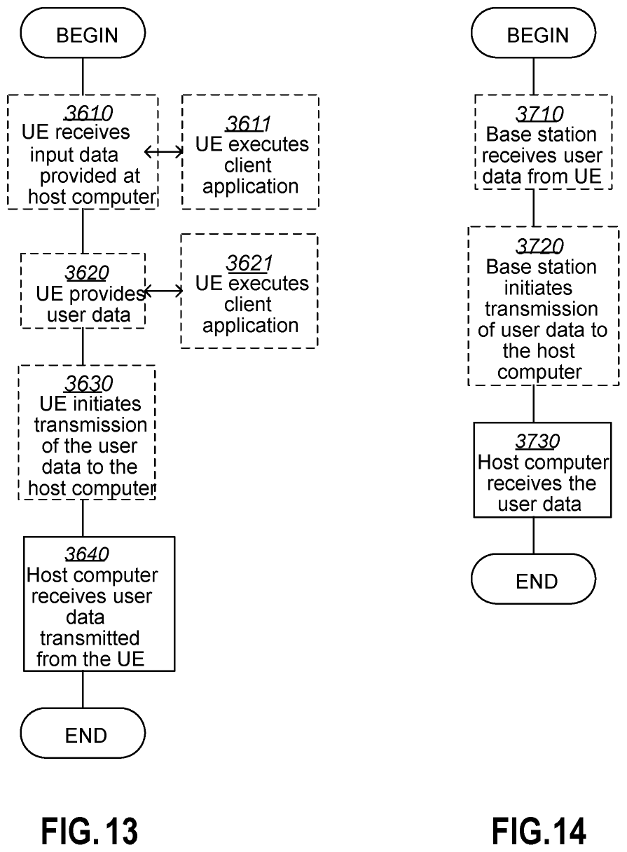

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 9 and FIG. 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

| Abbreviation | Explanation |
|---|---|
| NR | New Radio |
| NSA | Non-Stand Alone |
| SA | Stand Alone |
| MeNB | Master eNB |
| SgNB | Secondary gNB |
| MR-DC | Multi-RAT Dual Connectivity |
| AMBR | Aggregate Maximum Bit Rate |
| ENDC | EUTRA-New Radio Dual Connectivity |
| MME | Mobility Management Entity |
| EPC | Evolved Packet Core |
| SPID | Subscriber Profile Identity |
| PDCP | Packet Data Convergence Protocol |
| RSRP | Reference Signal Received Power |
| RSRQ | Reference Signal Received Quality |

1. A method performed by a first network node for selecting a first secondary cell for supporting split bearer mode with a first wireless device in a wireless communications network, wherein the first wireless device is one of a group of wireless devices for which a first cell provided by the first network node acts as a primary cell, and wherein the group of wireless devices are configured to measure signal quality of secondary cell candidates, the method comprising:
configuring the group of wireless devices with a first threshold value relating to a measured signal quality for determining whether-ally one or more secondary cell candidate shall be reported to the first network node;
receiving from the first wireless device, a first report comprising a measured signal quality for a respective one or more secondary cell candidate whose measured signal quality meets the first threshold value;
selecting, for the first wireless device, among the one or more secondary cell candidate received in the first report, a first secondary cell candidate, based on the first report;
instructing the first wireless device to attach to the first secondary cell candidate; and
in response to detecting that the first wireless device has failed a first series of random access attempts to the first secondary cell candidate configuring the first wireless device with a second threshold value that for a time period shall be used by the first wireless device instead of the first threshold value for determining whether any secondary cell candidate shall be reported to the first network node, wherein the second threshold value relates to a better signal quality than the first threshold value.

2. The method according to claim 1 further comprising:
receiving from the first wireless device, a second report comprising a measured signal quality of a respective one or more secondary cell candidate whose measured signal quality meets the second threshold value; and
selecting, for the first wireless device, among the one or more secondary cell candidate received in the second report, a second secondary cell candidate based on the second report.

3. The method according to claim 2 further comprising:
instructing the first wireless device to attach to the second secondary cell candidate.

4. The method according to claim 2 further comprising:
in response to detecting that the first wireless device has failed the first series of random access attempts to the second secondary cell candidate, configuring the first wireless device with a third threshold value that for a time period shall be used by the first wireless device instead of the second threshold value for determining whether any secondary cell candidate shall be reported to the first network node, wherein the third threshold value relates to a better signal quality than the second threshold value.

5. The method according to claim 1 further comprising:
in response to detecting that the first wireless device has succeeded to random access any of the secondary cell candidate, configuring the first wireless device with the first threshold value.

6. The method according to claim 1, wherein the better signal quality comprises any one or more out of:
a stronger signal strength,
a higher Signal-to-Noise and Interference Ratio (SINR), and
a longer evaluation period.

7. The method according to claim 1, wherein the first report comprises any one out of:
a received Reference Signal Received Power (RSRP) value,
a received Reference Signal Received Quality (RSRQ) value, and
a received Signal-to-Noise and Interference Ratio (SINR) value.

8. The method according to claim 1, wherein the time period that the second threshold value shall be used by the first wireless device relates to any one out of:
a predetermined time,
a successful random access attempt, and
a failed series of random access attempts.

9. The method according to claim 1, wherein the first wireless device comprises two or more wireless devices.

10. The method according to claim 1, wherein any one or more out of:
configuring the group of wireless devices,
receiving from the first wireless device, the first report,
selecting, for the first wireless device, among the one or more secondary cell candidate,
instructing the first wireless device to attach to the first secondary cell candidate,
detecting that the first wireless device has failed the first series of random access attempts to the first secondary cell candidate, and
configuring the first wireless device,
are part of, or based on, a Radio Resource Control (RRC) procedure.

11-12. (canceled)

13. A first network node configured to select a first secondary cell for supporting split bearer mode with a first wireless device in a wireless communications network, wherein the first wireless device is one of a group of wireless devices for which a first cell provided by the first network node acts as a primary cell, and wherein the group of wireless devices are configured to measure signal quality of secondary cell candidates, wherein the first network node comprising:
a processor; and
a memory comprising instructions which, when executed by the processor, cause the first network node to:
configure the group of wireless devices with a first threshold value relating to a measured signal quality for determining whether one or more secondary cell candidate shall be reported to the first network node;
receive from the first wireless device, a first report comprising a measured signal quality for a respective one or more secondary cell candidate whose measured signal quality is arranged to meet the first threshold value;
select, for the first wireless device, among the one or more secondary cell candidate received in the first report, a first secondary cell candidate, based on the first report;
instruct the first wireless device to attach to the first secondary cell candidate;
detect that the first wireless device has failed a first series of random access attempts to the first secondary cell candidate; and
in response to detecting, that the first wireless device has failed the first series of random access attempts, configure the first wireless device with a second threshold value that for a time period shall be used by the first wireless device instead of the first threshold value for determining whether any secondary cell candidate/s candidate shall be reported to the first network node, wherein the second threshold value relates to a better signal quality than the first threshold value.

14. The first network node according to claim 13 further to:
receive from the first wireless device, a second report comprising a measured signal quality of a respective one or more secondary cell candidate whose measured signal quality is arranged to meet the second threshold value; and
select, for the first wireless device, among the one or more secondary cell candidate received in the second report, a second secondary cell candidate based on the second report.

15. The first network node according to claim 14 further to:
instruct the first wireless device to attach to the second secondary cell candidate.

16. The first network node according to claim 14 further to:
detect that the first wireless device has failed the first series of random access attempts to the second secondary cell candidate; and
in response to detecting that the first wireless device has failed the first series of random access attempts, configure the first wireless device with a third threshold value that for a time period shall be used by the first wireless device instead of the second threshold value for determining whether any secondary cell candidate shall be reported to the first network node, wherein the third threshold value is adapted to relate to a better signal quality than the second threshold value.

17. The first network node according to claim 13 further to:
detect that the first wireless device has succeeded to random access any of the secondary cell candidate; and
in response to detecting that the first wireless device has succeeded to random access any secondary cell candidate, configure the first wireless device with the first threshold value.

18. The first network node according to claim 13, wherein the better signal quality is adapted to comprise any one or more out of:
a stronger signal strength,
a higher Signal-to-Noise and Interference Ratio (SINR), and
a longer evaluation period.

19. The first network node according to claim 13, wherein the first report comprise any one out of:
a received Reference Signal Received Power (RSRP) value,
a received Reference Signal Received Quality (RSRQ) value, and
a received Signal-to-Noise and Interference Ratio (SINR) value.

20. The first network node according to claim 13, wherein the time period that the second threshold value shall be used by the first wireless device relates to any one out of:
a predetermined time,
a successful random access attempt, and
a failed series of random access attempts.

21. The first network node according to claim 13, wherein the first wireless device comprises two or more wireless devices.

22. The first network node according to claim 13, wherein the first network node to configure any one or more out of:
configure the group of wireless devices,
receive from the first wireless device, the first report,
select, for the first wireless device, among the one or more secondary cell candidate,
instruct the first wireless device to attach to the first secondary cell candidate,
detect that the first wireless device has failed the first series of random access attempts to the first secondary cell candidate, and
configure the first wireless device,
are part of, or based on, a Radio Resource Control (RRC) procedure.
